(19) United States
(12) Patent Application Publication
(10) Pub. No.: US 2008/0219366 A1
(43) Pub. Date: Sep. 11, 2008

(54) COMBINED RATE AND PRECODER DESIGN FOR SLOW FADING CORRELATED MIMO CHANNELS WITH LIMITED FEEDBACK

(75) Inventors: Vincent Kin Nang Lau, Hong Kong (CN); Bao San Ming Mok, Hong Kong (CN)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: The Hong Kong University of Science and Technology, Hong Kong (CN)

(21) Appl. No.: 12/039,869

(22) Filed: Feb. 29, 2008

Related U.S. Application Data
(60) Provisional application No. 60/894,094, filed on Mar. 9, 2007.

(51) Int. Cl. H04K 1/10

(52) U.S. Cl. 375/260

(57) ABSTRACT

System and methodologies are provided herein for joint rate, precoder, and feedback design adaptation and optimization for wireless communication systems. An optimization component as provided herein can implement an integrated framework for joint design of rate, preceding, and feedback partitioning adaptation policies for slow fading and spatially correlated multiple-input multiple-output (MIMO) communication channels with limited feedback. The optimization component can utilize one or more vector quantization (VQ) optimization techniques wherein a feedback strategy and a transmission adaptation strategy are designed to jointly optimize average system goodput (e.g., average bits/second/Hz successfully delivered to a receiver) based on spatial correlation of the communication channels. In one example, a feedback strategy is designed as a channel state information of receiver (CSIR) partition and a transmission adaptation strategy is designed as rate and precoder codebooks.

### CROSS-REFERENCE

This application claims the benefit of U.S. Provisional Patent Application Ser. No. 60/894,094, filed on Mar. 9, 2007, entitled “COMBINED RATE AND PRECODER DESIGN FOR SLOW FADING CORRELATED MIMO CHANNELS WITH LIMITED FEEDBACK.”

### TECHNICAL FIELD

The present disclosure relates generally to wireless communications systems, and more particularly to techniques for rate, power and precoder adaptation and optimization for wireless communication systems.

### BACKGROUND

Conventionally, channel state information of transmitter (CSIT) is utilized to improve the spectral efficiency of multiple-input multiple-output (MIMO) communication systems by, for example, facilitating precoder and power adaptation at a wireless transmitter. In practice, however, CSIT obtained in a communication system, such as a frequency division duplexing (FDD) system, is imperfect due to a limited number of bits allotted for CSIT feedback. As a result, a large amount of research has traditionally focused on techniques for providing CSIT feedback and facilitating system adaptation based on limited received CSIT feedback in order to best utilize the limited feedback resources of MIMO systems.

Traditional approaches to limited feedback system design, however, consider only precoder design and/or power adaptation for independent and identically distributed MIMO fast fading channels. These approaches do not address rate adaptation or the presence of correlated MIMO channels, which can significantly affect system performance for slow fading channels and practical antenna designs, respectively. Further, traditional approaches to limited feedback design ignore the effects of packet transmission errors, which can cause significant degradation in system performance. For example, in slow fading channels, having access only to limited CSIT feedback necessarily creates uncertainty regarding instantaneous mutual information. Accordingly, packet outage (and, consequentially, packet errors) can be experienced if a transmitted data rate exceeds the instantaneous mutual information. Because traditional techniques for MIMO system design ignore the effects of packet outage, systems designed using such techniques can therefore experience packet errors even if strong channel coding is utilized.

Further, existing limited feedback design techniques are traditionally formulated for independent and identically distributed MIMO channels. However, in practice, spatial correlation exists between MIMO antennas due to factors such as limited available antenna spacing and non-dense scattering environments, rendering these techniques inapplicable. More recent research into limited feedback design techniques for correlated MIMO channels has been conducted; however, these techniques again ignore the effect of potential packet outage and therefore do not fully address the problems noted above. Accordingly, there exists a need in the art for addressing packet outage in slow fading correlated MIMO channels with limited feedback.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present disclosure provides systems and methodologies for rate, power, precoder, and feedback design adaptation for wireless communication systems such as MIMO communication systems with slow fading, spatially correlated channels and limited feedback. In accordance with one aspect, an integrated framework is applied to design rate and precoding adaptation policies for slow fading correlated MIMO channels with limited feedback. The limited feedback design can, for example, be modeled as a vector quantization (VQ) optimization problem, in which a feedback strategy and a transmission adaptation strategy are designed to jointly optimize average system goodput. In accordance with one aspect, average system goodput measures the average bits/second/Hz (b/s/Hz) successfully delivered to a receiver and can be used as a performance measure for various techniques described herein in order to capture the penalty of potential packet errors. In one example, feedback can be provided via a channel state information of receiver (CSIR) partition, and a transmission adaptation strategy can be implemented via rate and precoder codebooks. In accordance with another aspect, spatial correlation between antennas can be taken into consideration in the design of the CSIR partition and rate and precoder codebooks.

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter can be employed. The claimed subject matter is intended to include all such aspects and their equivalents. Other advantages and novel features of the claimed subject matter can become apparent from the following detailed description when considered in conjunction with the drawings.

### BRIEF DESCRIPTION OF THE DRAWINGS

FIG. 1 is a high-level block diagram of a wireless communication system in accordance with various aspects.

FIG. 2 is a block diagram of an example wireless communication system in accordance with various aspects.

FIG. 3 is a block diagram of a system for rate, precoder, and feedback strategy adaptation in a wireless communication system in accordance with various aspects.

FIG. 4 is a block diagram of a system that facilitates optimized communication with at least one wireless receiver in a wireless communication system in accordance with various aspects.

FIG. 5 is a flowchart of a method that facilitates optimization of a wireless communication system.

FIG. 6 is a flowchart of a method of providing rate, precoder, and channel state partitioning adaptation in a wireless communication system.

FIG. 7 is a flowchart of a method of joint rate, precoder, and feedback partitioning design for a wireless transmitter/receiver pair communicating over a slow fading correlated MIMO channel with limited feedback.

FIG. 8 is a flowchart of a method of communicating via a wireless receiver with at least one wireless transmitter in a wireless communication system.

FIG. 9 is a block diagram of an example operating environment in which various aspects described herein can function.

FIG. 10 illustrates an overview of a wireless network environment suitable for service by various aspects described herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, the methods and apparatus of the claimed subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the claimed subject matter. The components may communicate via local and/or remote processes such as in accordance with a signal having one or more data packets (e.g., data from one component interacting with another component in a local system, distributed system, and/or across a network such as the Internet with other systems via the signal).

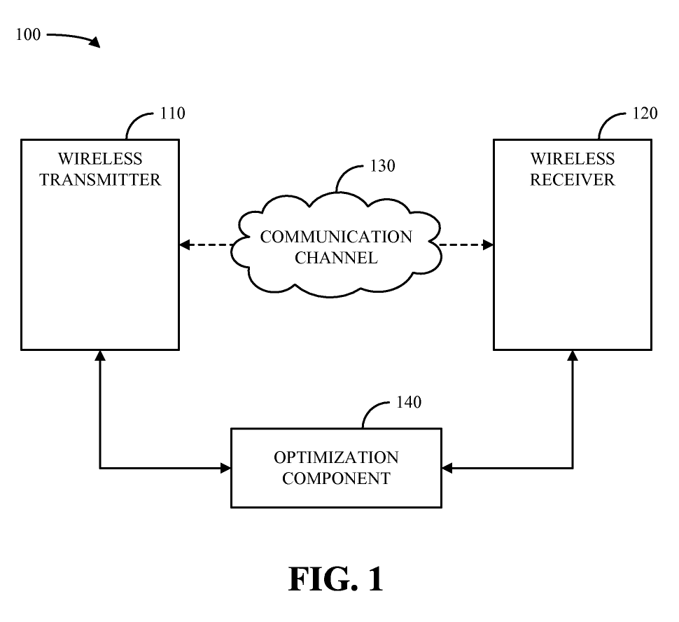

Referring to FIG. 1, a high-level block diagram of a wireless communication system 100 in accordance with various aspects presented herein is illustrated. In accordance with one aspect, system 100 can include a wireless transmitter 110 and a wireless receiver 120, which can communicate data, control signaling, and/or other information over a wireless communication link or channel 130. It should be appreciated, however, that the designations illustrated in FIG. 1 are provided by way of example and not limitation and that information can be communicated in system 100 from the wireless receiver 120 to the wireless transmitter 110 as well as from the wireless transmitter 110 to the wireless receiver 120.

In one example, the wireless transmitter 110 and/or wireless receiver 120 can comprise and/or provide the functionality of a wireless terminal, which can be a self-contained device such as a cellular telephone, a personal digital assistant (PDA), or another suitable device, connected to a computing device such as a laptop computer or desktop computer, and/or another suitable type of device. A wireless terminal can be called a system, subscriber unit, subscriber station, mobile station, mobile, remote station, remote terminal, access terminal, user terminal, user agent, user device, user equipment, etc. Additionally and/or alternatively, one or more wireless transmitters 110 and/or wireless receivers 120 in the system 100 can comprise and/or provide the functionality of a wireless access point or base station by, for example, serving as a router between one or more other stations and a wireless access network associated with the access point.

In accordance with one aspect, the wireless transmitter 110 and the wireless receiver 120 can include multiple antennas such that communication can be conducted between the wireless transmitter 110 and the wireless receiver 120 over a MIMO communication link. It is to be appreciated that such communication can be conducted according to any now-existing or future communication techniques and/or combinations thereof. Additionally, as used herein, “forward link” or “downlink” communication refers to communication from a transmitter 110 to a receiver 120, while “reverse link” or “uplink” communication refers to communication from a receiver 120 to a transmitter 110.

In accordance with one aspect, a wireless receiver 120 in system 100 can determine information relating to the state of the communication channel 130 between the wireless transmitter 110 and wireless receiver 120 (e.g., CSIR) as such information is available to the wireless receiver 120. This information can then be relayed by the wireless receiver 120 as CSIT feedback to the wireless transmitter 110. Based on this CSIT feedback, the wireless transmitter 110 can select one or more adaptation policies for communication with the wireless receiver 120. For example, based on a CSIT signal received from the wireless receiver 120, the wireless transmitter 110 can select a transmission mode based on one or more pre-designed adaptation codebooks or policies. In one example, these adaptation policies or codebooks can include information for a precoder matrix, transmission rate, and/or transmission power to be utilized in subsequent communication with the wireless receiver 120.

In accordance with another aspect, knowledge of CSIT can be utilized to improve the spectral efficiency of system 100 through operations such as precoder and power adaptation at the transmitter 110. Further, CSIT can be utilized by system 100 to improve ergodic capacity through rate adaptation. In practice, however, CSIT obtained at the transmitter 110 is often imperfect due to a limited number of bits allowed for CSIT feedback in system 100. Thus, techniques for effectively utilizing limited feedback capacity have traditionally been a major area of research in MIMO system design.

One existing approach to the limited feedback problem involves formulation of the problem as a VQ problem with a modified distortion measure, wherein a modified Lloyd's algorithm is utilized to optimize system ergodic capacity. Another existing approach utilizes precoder design for point-to-point MIMO links with limited feedback to optimize the signal-to-noise ratio (SNR) using Grassmannian packing. Alternatively, other existing approaches utilize precoder design for minimizing the minimum mean-square error (MMSE) under limited feedback. However, these existing approaches consider only precoder design and/or power adaptation for independent and identically distributed (i.i.d.) MIMO fast fading channels. Because rate adaptation and correlation between MIMO channels are ignored, existing approaches to the limited feedback problem are significantly less effective for slow fading channels and practical antenna designs. For example, traditional limited feedback designs often utilize ergodic capacity and/or SNR as performance measures. However, these measures are less meaningful for slow fading channels because they do not take potential packet transmission errors into account.

As generally known in the art, factors that contribute to potential packet transmission errors include channel noise and channel outage. Channel noise can be overcome by utilizing strong channel coding with a sufficiently large block length. In contrast, however, channel outage is systematic and cannot be avoided merely by applying strong coding. In slow fading channels with limited CSIT, the limited amount of CSIT feedback available causes uncertainty regarding instantaneous mutual information. Accordingly, packet outage (and, consequently, packet error) will be experienced if a transmitted data rate exceeds the instantaneous mutual information, even if powerful channel coding is applied. Thus, rate adaptation is needed for controlling potential packet errors due to channel outage in slow fading channels. Strategies for rate adaptation, however, have not been considered in existing limited feedback designs.

In addition, many existing limited feedback designs consider the case of i.i.d. MIMO channels. However, spatial correlation often exists between MIMO antennas in practice due to, for example, limited available antenna spacing and non-dense scattering environments. Traditional techniques, such as Grassmannian packing, have proven inapplicable to correlated MIMO channels. More recent existing approaches have attempted to utilize a heuristic limited feedback design for precoder design on correlated MIMO channels with limited feedback. However, like the existing approaches noted above, such an approach results in degraded system performance because it does not consider the effects of potential packet outage.

In light of the above, system 100 can include an optimization component 140 in accordance with various aspects to address packet outage in the presence of slow fading and spatially correlated MIMO channels with limited feedback, thereby improving the overall performance of system 100. In one example, the optimization component can be communicatively connected to the wireless transmitter 110 and/or the wireless receiver 120, and can optimize system 100 by jointly initializing and/or adjusting various parameters of the wireless transmitter 110 and/or the wireless receiver 120. These parameters can include, for example, power, rate, and/or precoding parameters utilized by the wireless transmitter 110 and/or feedback parameters utilized by the wireless receiver 120. It should be appreciated, however, that while the optimization component 140 is illustrated in system 100 as a single distinct entity from the wireless transmitter 110 and the wireless receiver 120, the optimization component 140 can be implemented wholly or in part at the wireless transmitter 110, the wireless receiver 120, and/or any other suitable entity in the system 100. Further, it should be appreciated that various aspects of the functionality of the optimization component 140 can be distributed between a plurality of different devices. By way of example, power, rate, and precoding adaptation functionality of the optimization component 140 can be implemented at the wireless transmitter 110, and feedback adaptation functionality of the optimization component 140 can be implemented at the wireless receiver 120. In such an example, the transmitter 110 and receiver 120 can communicate directly with each other and/or indirectly with an external entity to jointly optimize their respective communication parameters.

In accordance with one aspect, the optimization component 140 can utilize system goodput, e.g., bits per second per Hertz (b/s/Hz) successfully delivered to the wireless receiver 120, as a performance measure in order to take potential packet errors and/or packet outage into account. In accordance with another aspect, the optimization component 140 can apply an integrated framework for the design of rate, preceding, and feedback adaptation for slow correlated MIMO fading channels with limited feedback. In one example, the optimization component 140 can formulate the limited feedback design problem as a VQ optimization problem, wherein a feedback strategy and a transmission adaptation strategy are designed to jointly optimize the average goodput of system 100. Feedback can be implemented, for example, as a CSIR partition, and the transmission adaptation strategy can be implemented, for example, with rate and precoder codebooks. In another example, spatial correlation between antennas is taken into consideration by the optimization component 140 in the adaptation and partition design.

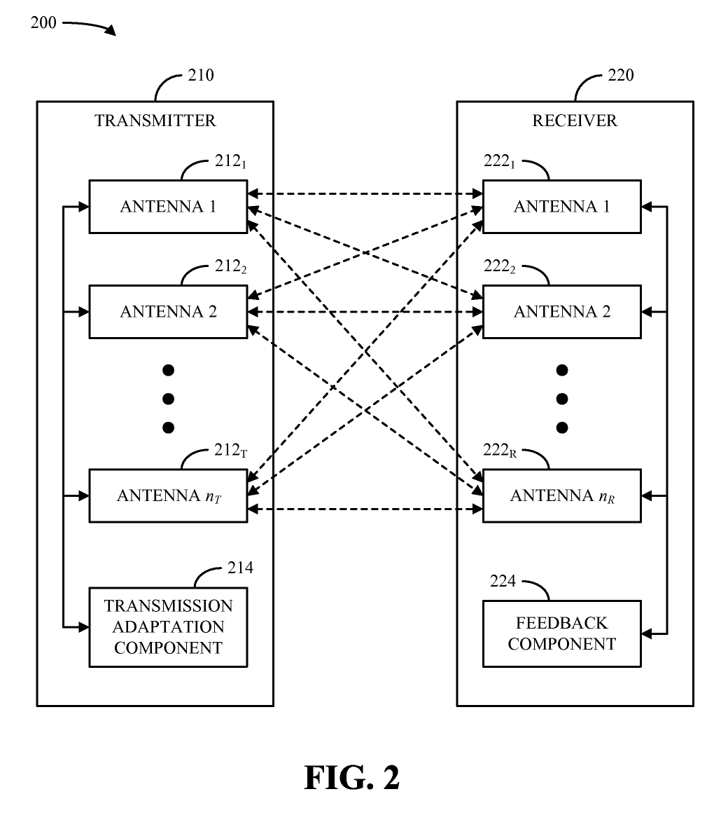

Referring now to FIG. 2, a block diagram of an example wireless communication system 200 is provided. In one example, system 200 is a point-to-point MIMO communication system between one or more transmitters 210 and one or more receivers 220. System 200 can, in accordance with one aspect, be based on a forward MIMO fading channel model, wherein n_{T} transmit antennas 212 at a transmitter 210 are utilized to communicate with n_{R} receive antennas 222 at a receiver 220. It should be appreciated that communication within system 200 can be conducted both from a transmitter 210 to a receiver 220 and from a receiver 220 to a transmitter 210. Further, it should be appreciated that system 200 can include any suitable number of transmitters 210 and/or receivers 220, each of which can respectively include any appropriate number of antennas 212 and/or 222.

In accordance with one aspect, the forward MIMO channel between the transmitter 210 and the receiver 220 can be modeled as follows. Based on a m×1 transmitted symbol X from the transmitter 210, the receiver 220 can receive a n_{R}×1 symbol Y, which can be given by the following:

Y=HVX+Z, (1)

where H is an n_{R}×n_{T} dimension channel matrix, V is an n_{T}×m orthonormal column matrix, m is the rank of H, and Z represents n_{R}×1 channel complex Gaussian noise with covariance matrix ε[ZZ*]=σ_{z}²Iₙ_{_{R}}, where ε[.] denotes expectation over all channel realizations. By utilizing singular value decomposition (SVD), H can be expressed as U_{H}Σ_{H}V′_{H}. In one example, the channel matrix is quasi-static across encoding and decoding frames. Consequently, even if powerful error correction coding is applied, there can be a non-zero probability of packet errors due to channel outage.

In accordance with another aspect, to take spatial correlation at the transmitter 210 and the receiver 220 into account, the channel matrix H can be modeled as follows:

H=Rᵣ^{1/2}H_{w}Rₜ^{1/2}, (2)

where Rᵣ=ε[HH^{H}] and Rₜ=ε[H^{H}H] are the n_{R}×n_{R} receive and n_{T}×n_{T} transmit correlation matrices, respectively. Additionally, as used in Equation (2), H_{w} is the n_{R}×n_{T} Rayleigh channel matrix. In one example, the elements of H_{w} are independently and identically Rayleigh distributed. Further, Rₜ and Rᵣ as used in Equation (2) represent the geometrical structure of the propagation channel. In one example, Rₜ and Rᵣ are similar and can be expressed as follows:

$${[ R ]}_{ik} = β {\sum }_{s = 1}^{S} exp ( 2 π j ( i - k ) \frac{Δ}{λ} cos {θ}_{s} ) , \qquad ( 3 )$$

where [R]ᵢₖ represents the (i,k)-th element of R, β is a normalizing factor, Δ is a spacing factor for antennas 212 and 222, λ is a wavelength, S represents major far-field scatterers at the transmitter 210 and receiver 220, and θₛ represents the direction of departure (DOD) and/or angle of arrival (AOA) for the s-th far-field scatterer. In one example, S is chosen to be sufficiently large compared with λ such that the channel condition is significantly affected only by the DOD/AOA or the angular spread of the transmitter and/or receiver scatterers. In accordance with one aspect, system 200 can employ equal power allocation, wherein the instantaneous mutual information of system 200 can be given by the following:

C(H,V)=log₂det(Iₘ+ρΣ_{H}²V′_{H}VV′V_{H}), (4)

where ρ=P_{T}/m.

In one example, the receiver 220 can employ a feedback component 224 to communicate channel state information (CSI) to the transmitter 210 based on a predetermined feedback strategy. The feedback strategy utilized by the feedback component 224 can, for example, be given by deterministic feedback. Thus, in accordance with one aspect, the CSI feedback strategy employed by the feedback component 224 can be characterized by a partition at the CSIR space. In particular, the CSI feedback strategy can be given by the partition H as follows:

H={H₁,H₂, . . . , H_{N },} (5)

where N=2^{C}^{_{fb}} is the number of regions in the partition and C_{fb} is the number of bits allowed for feedback. Furthermore, for a given partition of the CSIR space H, it can be observed that

$$ℋ = {⋃}_{i = 1}^{N} {H}_{i} and {H}_{i} ⋂ {H}_{j} = ∅ for i \neq j .$$

In accordance with one aspect, a transmission adaptation component 214 can be employed at the transmitter 210 to enable transmission of data based at least in part on a set of precoder parameters V and a set of transmission rate parameters R. In one example, precoder and transmission rate parameters utilized by the transmission adaptation component 214 can be adaptive based on limited CSIT feedback provided by the receiver 220 via the feedback component 224. In another example, the rate and precoder parameters can be defined by respective codebooks {R}={R₁, R₂, . . . , R_{N}} and {V}={V₁, V₂, . . . , V_{N}}.

In accordance with another aspect, CSIT feedback and resulting adaptation can be conducted in real time within system 200 as follows. First, the feedback component 224 at the receiver 220 can estimate the CSIR H and determine a region of the CSIR partition H in which the estimated CSIR is located. Next, the feedback component 224 can determine an index i corresponding to the determined region, which can then be communicated from the receiver 220 to the transmitter 210. In one example, the index communication is limited to C_{fb}. Finally, upon receiving an index i at the transmitter 210, the transmission adaptation component 214 at the transmitter 210 can obtain transmission rate and precoder parameters corresponding to the i-th entry of predetermined rate and precoder codebooks. Accordingly, a selected rate and precoder can be given by the following:

R(CSIT)=Rᵢ and V(CSIT)=Vᵢ if Hε{Hᵢ}. (6)

Based on the above feedback and adaptation process, a limited feedback design for system 200 can include design of the offline CSIR partition H at the receiver 220 and the rate and precoder codebooks {R} and {V} at the transmitter 210. Techniques that can be utilized for design and offline optimization of these system parameters are described in further detail infra.

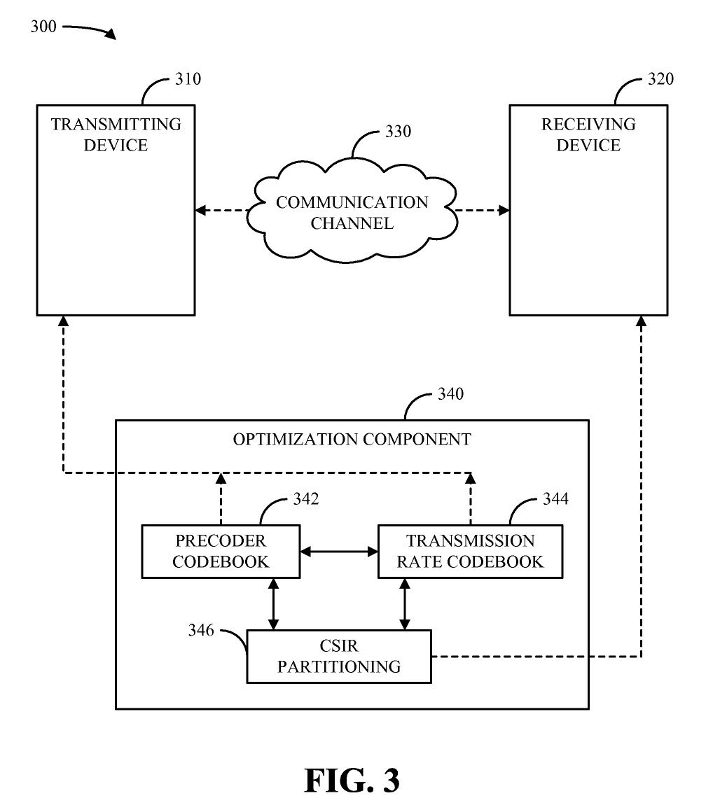

Turning to FIG. 3, a system 300 for rate, precoder, and feedback strategy adaptation in a wireless communication system is illustrated. In one example, the system 300 can include a transmitting device 310 and a receiving device 320 that are operable to communicate over a communication channel 330. In addition, the system 300 can include an optimization component 340 communicatively coupled to the transmitting device 310 and the receiving device 320. In accordance with one aspect, the optimization component 340 can facilitate optimized communication in system 300 by initializing and adjusting various parameters for use by the transmitting device 310 and/or the receiving device 320. By way of specific example, the optimization component 340 can facilitate design of a precoder codebook 342 and a transmission rate codebook 344, respectively denoted herein as {V} and {R}, to the transmitting device 310, and a CSIR partition 346, denoted herein as H, to the receiving device 320. In accordance with another aspect, the optimization component 340 can utilize an optimization algorithm based on vector quantization.

In accordance with one aspect, due to slow fading, limited feedback capacity, and/or other characteristics of the communication channel 330, uncertainty can exist for instantaneous mutual information at the transmitting device 310 given particular CSIT feedback from the receiving device 320. Thus, even if powerful channel coding is applied, system 300 can experience packet errors and packet outage. In one example, to capture the penalty of these potential packet errors on the performance of system 300, the optimization component 340 can operate in consideration of system goodput, which measures the b/s/Hz successfully delivered to the receiving device 320. Instantaneous goodput can be defined as φ=R1(R<C(H,V)), where 1(.) is an indicator function. Based on this definition, average system goodput can be given by the following:

$$\begin{matrix}\overline{ϕ} = ℰ [ R \times 1 ( R < C ( H , V ) ) ] \\ = {\sum }_{i = 1}^{N} ℰ [ {R}_{i} \times 1 ( {R}_{i} < C ( H , {V}_{i} ) ) \vert H ∈ {H}_{i} ] Pr [ H ∈ {H}_{i} ] . \\ = {\sum }_{i = 1}^{N} {R}_{i} Pr [ {R}_{i} < C ( H , {V}_{i} ) \vert H ∈ {H}_{i} ] Pr [ H ∈ {H}_{i} ] .\end{matrix} \qquad ( 7 )$$

Further, by adopting the feedback strategy in Equation (6), it can be appreciated that the average system goodput is equivalent to the following:

$${\sum }_{i = 1}^{N} {R}_{i} Pr [ {R}_{i} < C ( H , {V}_{i} ) \vert H ∈ {H}_{i} ] Pr [ H ∈ {H}_{i} ] . \qquad ( 8 )$$

In one example, the optimization component 340 can facilitate optimized communication in system 300 by selecting a CSIR partition {H} and transmitter codebook {{R}, {V}} that maximizes the average system goodput. This determination can be expressed as follows:

$$( \{ {H}_{i}^{*} \} , \{ {R}_{i}^{*} \} , \{ {V}_{i}^{*} \} ) = arg {max}_{\{ {H}_{i} \} , \{ {R}_{i} \} , \{ {V}_{i} \}} \overline{ϕ} ( \{ {H}_{i} \} , \{ {R}_{i} \} , \{ {V}_{i} \} ) , \qquad ( 9 )$$

subject to the restriction

$${\sum }_{i = 1}^{N} ( {V}_{i}^{′} {V}_{i} ) Pr [ H ∈ {H}_{i} ] = {I}_{m} .$$

In addition, a “modified distortion” between CSIR H and an i-th region therein can be defined as follows:

d(H,i)=Rᵢ×1(Rᵢ<C(H,Vᵢ)). (10)

Further, it should be appreciated that the average goodput of system 300, which can be employed as the optimization objective of the optimization component 340, can be expressed as follows:

$$\overline{ϕ} = {\sum }_{i = 1}^{N} ɛ [ d ( H , i ) \vert H ∈ {H}_{i} ] Pr [ H ∈ {H}_{i} ] . \qquad ( 11 )$$

As a result, in accordance with one aspect, an optimization problem formulated by the optimization component 340 for system 300 can be regarded as equivalent to the general VQ problem. Thus, the optimization component 340 can utilize Lloyd's procedure to solve for the optimal precoder codebook 342, transmission rate codebook 344, and CSIR partitioning 346 as described below.

In accordance with one aspect, the optimization component 340 can utilize Lloyd's algorithm for determining optimal parameters for the transmitting device 310 and/or the receiving device 320 as follows. First, given transmission rate and precoder adaptation policies {R} and {V}, the optimization component 340 can compute an optimal CSIR partition {H}. Second, given a partition H, the optimization component 340 can compute optimal rate and precoder parameters Vᵢ and Rᵢ. In one example, these operations can be iterated by the optimization component 340 until a convergence condition is reached. Additionally and/or alternatively, the optimization component 340 can iteratively perform the described operations for a predetermined number of optimization trials. In one example, each optimization trial can be initialized using randomly initialized feedback parameters and executed to a local condition of convergence. Based on the results of each trial, a set of parameters corresponding to the trial that yields the largest system goodput can be selected.

In one example, the first of the above-described operations, e.g., computation of an optimal CSIR partition {H} given adaptation policies {R} and {V}, can be conducted by the optimization component 340 as follows. Initially, based on the optimization problem formulated by the optimization component 340, a partition H*ᵢ can be regarded as optimal if the following condition is met:

$$\begin{matrix}{H}_{i} = \{ H ∈ {C}^{{n}_{R} \times {n}_{T}} : d ( H , i ) \geq d ( H , j ) ∀ i \neq j \} \\ = \{ H ∈ {C}^{{n}_{R} \times {n}_{T}} : {R}_{i} \times 1 [ C ( H , {V}_{i} ) > {R}_{i} ] \geq {R}_{j} \times \\ 1 [ C ( H , {V}_{j} ) > {R}_{j} ] ∀ i \neq j \} .\end{matrix} \qquad ( 12 )$$

Further, to simplify the CSIR partitioning, the optimization component 340 can sort a set of transmission rates {R_{[i]}} in descending order such that, e.g., R_{[1]}≧R_{[2]}≧ . . . ≧R_{[N]}. As a result, a partition H*_{[i]} can be identified as an optimal partition by the optimization component 340 if the below conditions are met:

H**_{[1]}={HεCⁿ^{_{R}}^{×n}^{_{T}}:C(H,V₁)≧R_{[1]}}

H**_{[i]}={HεCⁿ^{_{R}}^{×n}^{_{T}}∉Hⱼ∀j≠i:C(H,Vᵢ)≧R_{[i]}}.

H**_{[N]}={HεCⁿ^{_{R}}^{×n}^{_{T}}∉Hᵢ∀i≠N} (13)

In another example, the second of the above-described operations, e.g., computation of optimal rate and precoder parameters Vᵢ and Rᵢ given a CSIR partition H, can be performed by the optimization component 340 as follows. Initially, it can be observed that an optimal Vᵢ and Rᵢ given a partition H can be decoupled between i=1, . . . , N. Thus, a set of optimal rate and precoder parameters (V*ᵢ, R*ᵢ) can be given by the following:

$$\begin{matrix}( {V}_{i}^{*} , {R}_{i}^{*} ) = arg {max}_{( {V}_{i} , {R}_{i} )} ɛ [ d ( H , i ) \vert H ∈ {H}_{i} ] \\ = arg {max}_{( {V}_{i} , {R}_{i} )} \{ {R}_{i} Pr [ C ( H , {V}_{i} ) > {R}_{i} \vert H ∈ {H}_{i} ] \} \\ = arg {max}_{( {Q}_{i} , {R}_{i} )} \\ \{ {R}_{i} Pr [ {log}_{2} det ( {I}_{m} + {ρΣ}_{H}^{2} {V}_{H}^{′} {V}_{i} {V}_{i}^{′} {V}_{H} ) > {R}_{i} \vert H ∈ {H}_{i} ] \} .\end{matrix} \qquad ( 14 )$$

In accordance with one aspect, the optimization component 340 can solve Equation (14) for a set of optimal transmitter parameters by finding the cumulative distribution function (cdf) of log₂det(.). It has been shown that log₂det(.) can be approximated by a Gaussian distribution for moderate n_{T} and n_{R}. Accordingly, the optimization component 340 can compute a Gaussian approximation for the conditional packet outage probability of system 300 by computing the conditional mean and conditional variance of the random variable log₂det

$$( {I}_{m} + {ρΣ}_{H}^{2} {V}_{H}^{′} {V}_{i} {V}_{i}^{′} {V}_{H} ) .$$

In one example, the conditional mean of the variable log₂det

$$( {I}_{m} + {ρΣ}_{H}^{2} {V}_{H}^{′} {V}_{i} {V}_{i}^{′} {V}_{H} )$$

can be computed by the optimization component 340 using the following:

$$\begin{matrix}{μ}_{C \vert i} = ɛ [ {log}_{2} det ( {I}_{m} + {ρΣ}_{H}^{2} {V}_{H}^{′} {V}_{i} {V}_{i}^{′} {V}_{H} \vert H ∈ {H}_{i} ) ] \\ \approx {log}_{2} det ( {I}_{m} + ρɛ [ {Σ}_{H}^{2} {V}_{H}^{′} {V}_{i} {V}_{i}^{′} {V}_{H} ] )\end{matrix} \qquad ( 15 )$$

It should be noted that the approximation given in the second step of Equation (15) is asymptotically tight for large values of ρ. Additionally and/or alternatively, the conditional variance of the variable log₂det

$$( {I}_{m} + {ρΣ}_{H}^{2} {V}_{H}^{′} {V}_{i} {V}_{i}^{′} {V}_{H} )$$

can be computed by the optimization component 340 as follows:

$${σ}_{C \vert i}^{2} = ɛ [ {log}_{2} {det}^{2} ( {I}_{m} + {ρΣ}_{H}^{2} {V}_{H}^{′} {V}_{i} {V}_{i}^{′} {V}_{H} ) \vert H ∈ {H}_{i} ] - {μ}_{C \vert i}^{2} . \qquad ( 16 )$$

Based on the above, the optimization component 340 can formulate the Lagrangian function of the optimization problem given by Equation (14) in terms of the Gaussian Q function as follows:

$$\begin{matrix}( {R}_{i} , {V}_{i} , λ ) = {R}_{i} Pr [ {log}_{2} det ( {I}_{m} + {ρΣ}_{H}^{2} {V}_{H}^{′} {V}_{i} {V}_{i}^{′} {V}_{H} ) > {R}_{i} \vert H ∈ {H}_{i} ] \\ - λ tr ( {V}_{i}^{′} {V}_{i} ) \\ = {R}_{i} Q ( \frac{{R}_{i} - {μ}_{C \vert i} ( {V}_{i} )}{{σ}_{C \vert i} ( {V}_{i} )} ) - λ tr ( {V}_{i}^{′} {V}_{i} ) .\end{matrix} \qquad ( 17 )$$

In accordance with one aspect, the optimization component 340 can employ the above equations to obtain optimized Vᵢ and Rᵢ parameters as follows. Initially, it is noted that the optimization Lagrangian function with respect to Vᵢ is not a convex function in Vᵢ. In light of this observation, the optimization component 340 can simplify the necessary calculations for optimization of Vᵢ by making use of the observation that the conditional variance σ_{C|i}² does not scale with the average SNR ρ and thus, for sufficiently large ρ, σ_{C|i}<<μ_{C|i}. In one example, this observation can be proven based on the following equation:

$$\begin{matrix}{σ}_{C \vert i}^{2} = ɛ [ {log}_{2} {det}^{2} ( {I}_{m} + {ρΣ}_{H}^{2} {V}_{H}^{′} {V}_{i} {V}_{i}^{′} {V}_{H} \vert H ∈ {H}_{i} ) ] - {μ}_{C \vert i}^{2} \\ = ɛ [ {log}_{2} {det}^{2} ( {I}_{m} + ρ {Σ}_{H}^{2} {V}_{H}^{′} {V}_{i} {V}_{i}^{′} {V}_{H} \vert H ∈ {H}_{i} ) ] - \\ {log}_{2} {det}^{2} ( {I}_{m} + ρ ɛ [ {Σ}_{H}^{2} {V}_{H}^{′} {V}_{i} {V}_{i}^{′} {V}_{H} \vert H ∈ {H}_{i} ] ) + \\ O ( const ) \leq {log}_{2} {det}^{2} ( {I}_{m} + {ρΣ}_{H}^{2} {V}_{H}^{′} {V}_{i} {V}_{i}^{′} {V}_{H} \vert H ∈ {H}_{i} ] ) - \\ {log}_{2} {det}^{2} ( {I}_{m} + ρɛ [ {Σ}_{H}^{2} {V}_{H}^{′} {V}_{i} {V}_{i}^{′} {V}_{H} \vert H ∈ {H}_{i} ] ) + O ( const ) \\ = O ( const ) ,\end{matrix} \qquad ( 18 )$$

where O(.) denotes an asymptotic upper bound and the inequality in the third step of Equation (18) is due to Jensen's inequality on ε[log₂det²(.)]. As a result, for large ρ, it can be appreciated that σ_{C|i}² is bounded by a constant that does not scale for ρ.

Based on the above observation, it can be appreciated that for large ρ, μ_{C|i} increases much faster than σ_{C|i}², which approaches a constant independent of ρ. As a result, optimization of the objective function with respect to Vᵢ can be regarded by the optimization component 340 as equivalent to optimizing the conditional mean μ_{C|i}. Therefore, in one example, the optimization component 340 can compute an optimal Vᵢ as follows:

$$\begin{matrix}{V}_{i}^{*} = arg {max}_{{V}_{i} \text{:} ( {V}_{i}^{′} {V}_{i} = {I}_{m} )} Q ( \frac{{R}_{i} - {μ}_{C \vert i} ( {V}_{i} )}{{σ}_{C \vert i}^{2} ( {V}_{i} )} ) \\ = arg {max}_{{V}_{i} \text{:} ( {V}_{i}^{′} {V}_{i} {I}_{m} )} {μ}_{C \vert i} ( {V}_{i} ) \\ = arg {max}_{{V}_{i} \text{:} ( {V}_{i}^{′} {V}_{i} {I}_{m} )} ɛ [ C ( H , {V}_{i} ) \vert H ∈ {H}_{i} ] .\end{matrix} \qquad ( 19 )$$

In accordance with one aspect, the calculation given by Equation (19) can be regarded as equivalent to minimizing capacity loss, which can be defined as follows:

$${C}_{L} ( H , V ) = - {log}_{2} det [ I - {( I + ρ {Σ}_{H}^{2} )}^{- 1} {ρΣ}_{H}^{2} ( I - {V}_{H}^{′} {VV}^{′} {V}_{H} ) ] . \qquad ( 20 )$$

In one example, when C_{fb} is reasonably large or P_{T}<<1, the capacity loss can be further approximated as follows:

$$\begin{matrix}{V}_{i}^{*} \approx {min}_{{V}_{i} \text{:} ( {V}_{i}^{′} {V}_{i} = {I}_{n} )} ɛ [ {tr ( {\tilde{Σ}}_{H} )}^{2} - tr ( {\tilde{Σ}}_{H}^{2} {V}_{H}^{′} {V}_{i} {V}_{i}^{′} {V}_{H} ) ] \\ = {max}_{{V}_{i} \text{:} ( {V}_{i}^{′} {V}_{i} {I}_{n} )} ( {\tilde{Σ}}_{H}^{2} {V}_{H}^{′} {V}_{i} {V}_{i}^{′} {V}_{H} ) \\ = {max}_{{V}_{i} \text{:} ( {V}_{i}^{′} {V}_{i} {I}_{n} )} ɛ [ {‖ {( {V}_{H} {\tilde{Σ}}_{H} )}^{′} {V}_{i} ‖}_{F}^{2} \vert H ∈ {H}_{i} ] \\ = ( n principal eigenvectors of ) ɛ [ {V}_{H} {\tilde{Σ}}_{H}^{2} {V}_{H} \vert H ∈ {H}_{I} ]\end{matrix} \\ where {\tilde{Σ}}_{H}^{2} = {( {I}_{N} + {ρΣ}_{H}^{2} )}^{- 1} {ρΣ}_{H}^{2} . \qquad ( 21 )$$

In accordance with another aspect, the optimization component 340 can compute an optimal value for Rᵢ as follows:

$$\frac{\partial }{{R}_{i}} \{ {R}_{i} Q ( \frac{{R}_{i} - {μ}_{C \vert i} ( {V}_{i} )}{{σ}_{C \vert i} ( {V}_{i} )} ) \} = 0 \\ ⇒ Q ( \frac{{R}_{i} - {μ}_{C \vert i} ( {V}_{i} )}{{σ}_{C \vert i} ( {V}_{i} )} ) - \frac{1}{2 π} {R}_{i} exp ( - \frac{{( {R}_{i} - {μ}_{C \vert i} )}^{2}}{2 {σ}_{C \vert i}^{2}} ) = 0. \qquad ( 22 )$$

In one example, optimization of Rᵢ based on Equation (22) can be performed at least in part by utilizing Newton's method and/or one or more other numerical techniques.

In light of the above description, the optimization component 340 in accordance with various aspects described herein can provide joint optimization for a precoder codebook 342, a transmission rate codebook 344, and/or a CSIR partitioning 346 for a transmitting device 310 and/or receiving device 320. By optimizing for slow fading, spatially correlated MIMO channels with limited feedback, the optimization component 340 can optimize the rate of successful information delivery from the transmitting device 310 to the receiving device 320 (e.g., the average goodput of system 300).

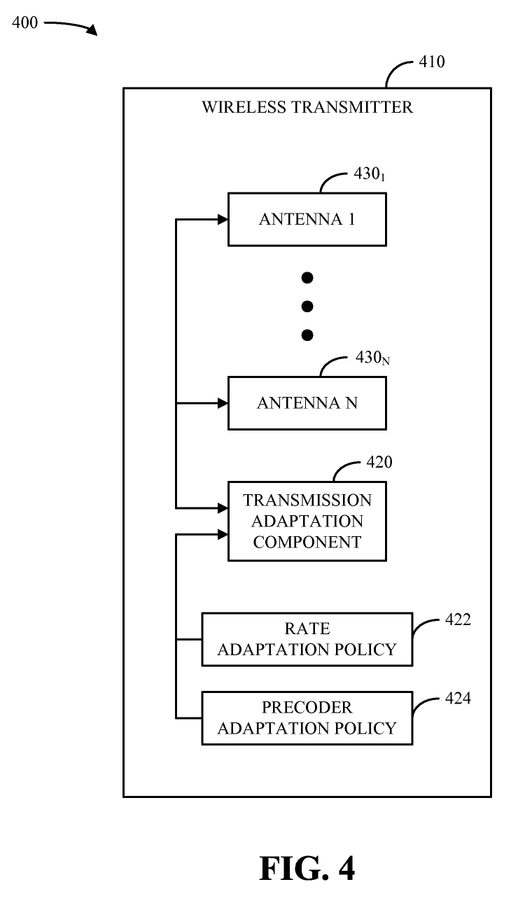

Turning to FIG. 4, a block diagram of a system 400 that facilitates optimized communication with at least one wireless receiver (e.g., a wireless receiver 120) in a wireless communication system is illustrated. As FIG. 4 illustrates, system 400 can include a wireless transmitter 410. In one example, the wireless transmitter 410 can communicate with one or more wireless receivers over one or more slow fading and spatially correlated multiple-input multiple-output (MIMO) communication channels with limited feedback capacity (e.g., communication channels 130).

In accordance with one aspect, the wireless transmitter 410 can include a transmission adaptation component 420, which can select a transmission mode for communicating with one or more wireless receivers based on a rate adaptation policy 422 and/or a precoder adaptation policy 424. In one example, the rate adaptation policy 422 and the precoder adaptation policy 424 can be jointly designed (e.g., by an optimization component 140) based at least in part on spatial correlation characteristics of MIMO communication channels over which the wireless transmitter 410 communicates. In accordance with another aspect, the wireless transmitter 410 can further include one or more antennas 430 that can communicate information to one or more wireless receivers based on a transmission mode selected by the transmission adaptation component 420.

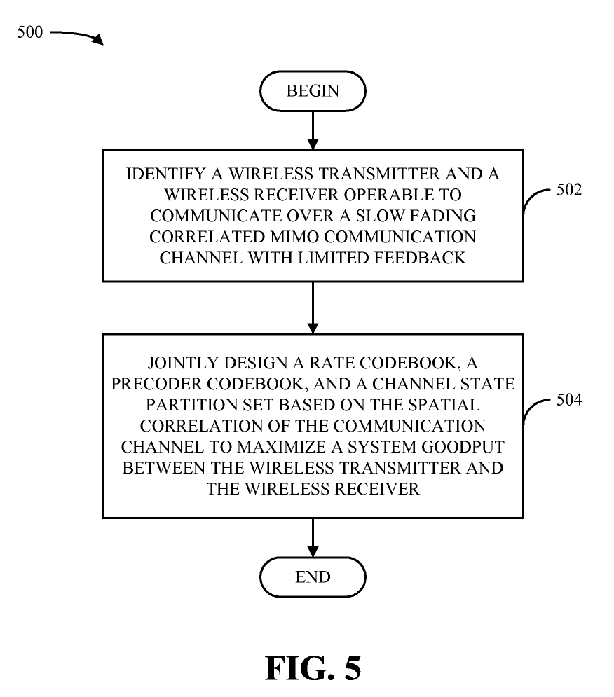

Referring now to FIGS. 5-8, methodologies that can be implemented in accordance with various aspects described herein are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies in accordance with the claimed subject matter.

Furthermore, the claimed subject matter may be described in the general context of computer-executable instructions, such as program modules, executed by one or more components. Generally, program modules include routines, programs, objects, data structures, etc., that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Referring to FIG. 5, a flowchart of a method 500 that facilitates optimization of a wireless communication system is illustrated. At 502, a wireless transmitter (e.g., a transmitting device 310) and a wireless receiver (e.g., a receiving device 320) are identified that are operable to communicate over a slow fading correlated MIMO communication channel with limited feedback (e.g., a communication channel 330). At 504, a rate codebook (e.g., a transmission rate codebook 344), a precoder codebook (e.g., a precoder codebook 342), and a channel state partition set (e.g., a CSIR partitioning 346) are jointly designed based on the spatial correlation of the communication channel over which the transmitter and receiver identified at 502 communicate to maximize a system goodput between the transmitter and receiver.

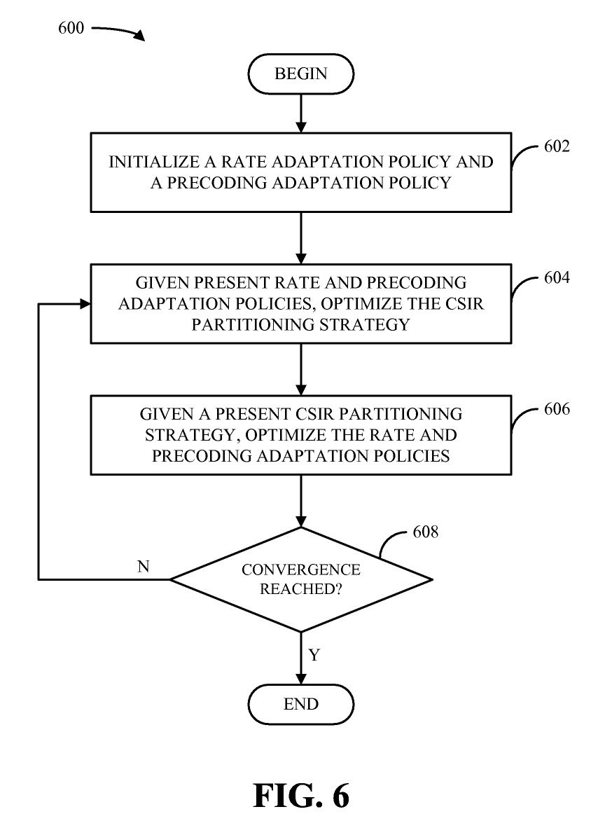

Turning now to FIG. 6, a flowchart of a method 600 of providing rate, precoder, and channel state partitioning adaptation in a wireless communication system is provided. At 602, a rate adaptation policy and a precoding adaptation policy are initialized. At 604, given the rate and precoding policies initialized at 602, a CSIR partitioning strategy is optimized. At 606, given the CSIR partitioning strategy optimized at 604, the rate and precoding adaptation policies are optimized.

In one example, the acts described at blocks 604 and 606 can be performed iteratively. Accordingly, at 608, it is determined whether a convergence condition has been reached. If convergence has been reached, method 600 concludes. Otherwise, method 600 returns to 604 to conduct further iterations of the acts described at blocks 604 and 606.

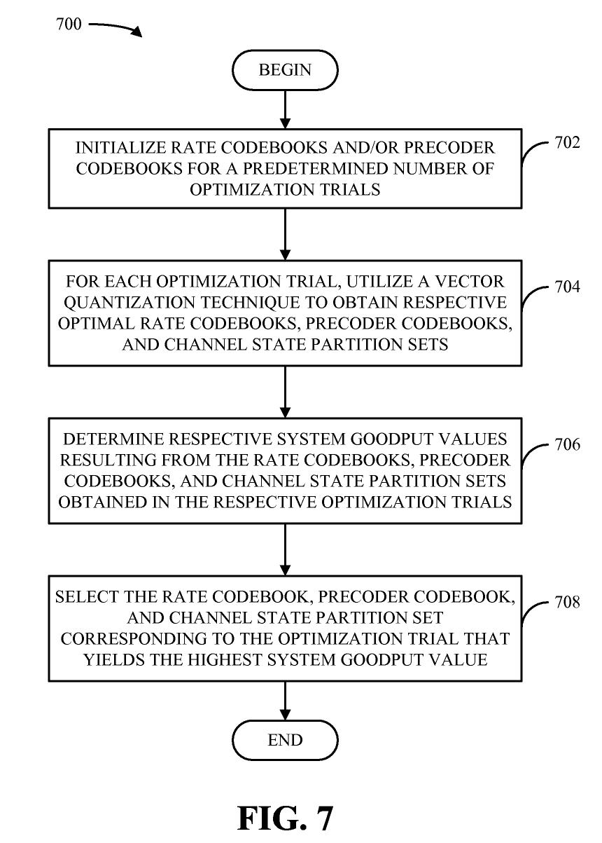

FIG. 7 illustrates a method 700 of joint rate, precoder, and feedback partitioning design for a wireless transmitter/receiver pair communicating over a slow fading correlated MIMO channel with limited feedback. At 702, rate codebooks and/or precoder codebooks are initialized for a predetermined number of optimization trials. At 704, for each optimization trial, a vector quantization technique is utilized to obtain respective optimal rate codebooks, precoder codebooks, and channel state partition sets. At 706, respective system goodput values resulting from the rate codebooks, precoder codebooks, and channel state partition sets obtained in the respective optimization trials conducted at 704 are determined. At 708, a rate codebook, precoder codebook, and channel state partition set is selected that corresponds to the optimization trial conducted at 704 that yielded the highest system goodput value as determined at 706.

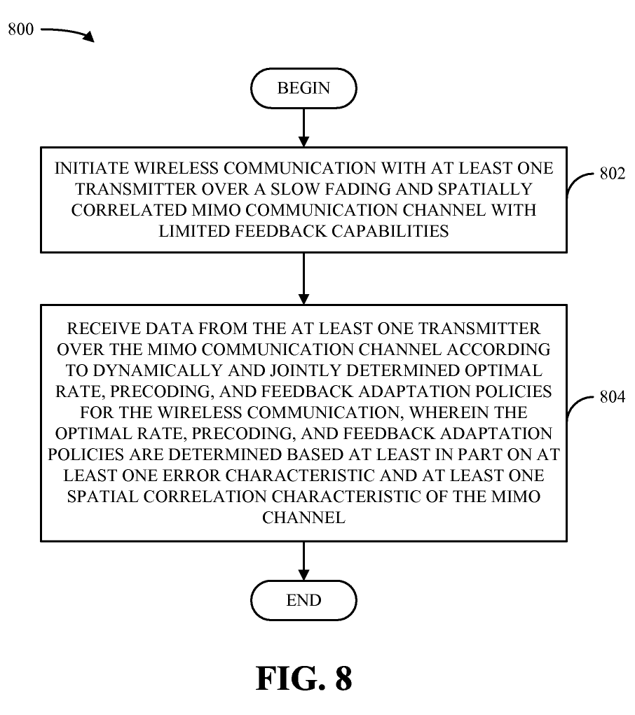

Referring now to FIG. 8, a flowchart of a method 800 of communicating via a wireless receiver with at least one wireless transmitter in a wireless communication system is provided. At 802, wireless communication with at least one transmitter over a slow fading and spatially correlated MIMO communication channel with limited feedback capabilities is initiated. At 804, data is received from the at least one transmitter with which wireless communication was initiated at 802 according to dynamically and jointly determined optimal rate, preceding, and feedback adaptation policies for the wireless communication. In accordance with one aspect, the optimal rate, preceding, and feedback adaptation policies utilized at 804 are determined based at least in part on at least one error characteristic and at least one spatial correlation characteristic of the MIMO channel over which communication is initiated at 802.

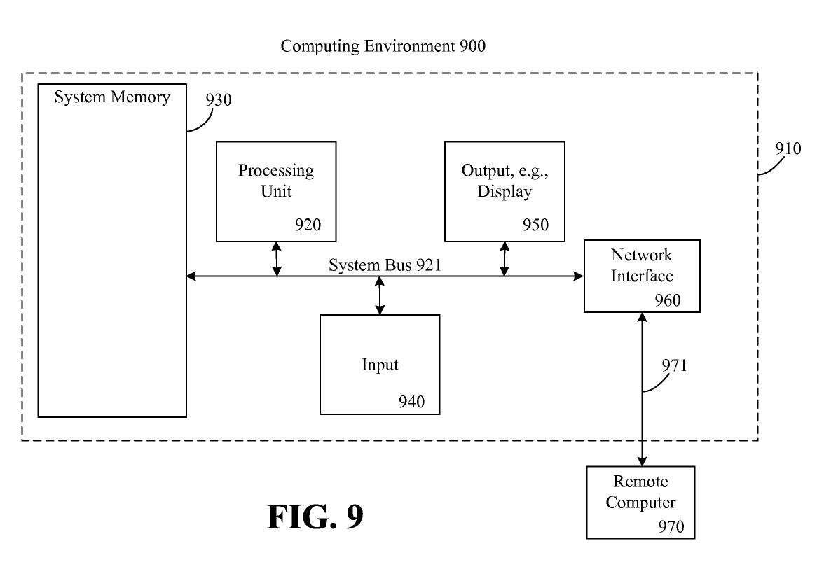

Turning to FIG. 9, an exemplary non-limiting computing system or operating environment in which various aspects described herein can be implemented is illustrated. One of ordinary skill in the art can appreciate that handheld, portable and other computing devices and computing objects of all kinds are contemplated for use in connection with the claimed subject matter, e.g., anywhere that a communications system may be desirably configured. Accordingly, the below general purpose remote computer described below in FIG. 9 is but one example of a computing system in which the claimed subject matter can be implemented.

Although not required, the claimed subject matter can partly be implemented via an operating system, for use by a developer of services for a device or object, and/or included within application software that operates in connection with one or more components of the claimed subject matter. Software may be described in the general context of computer-executable instructions, such as program modules, being executed by one or more computers, such as client workstations, servers or other devices. Those skilled in the art will appreciate that the claimed subject matter can also be practiced with other computer system configurations and protocols.

FIG. 9 thus illustrates an example of a suitable computing system environment 900 in which the claimed subject matter can be implemented, although as made clear above, the computing system environment 900 is only one example of a suitable computing environment for a media device and is not intended to suggest any limitation as to the scope of use or functionality of the claimed subject matter. Further, the computing environment 900 is not intended to suggest any dependency or requirement relating to the claimed subject matter and any one or combination of components illustrated in the example operating environment 900.

With reference to FIG. 9, an example of a remote device for implementing various aspects described herein includes a general purpose computing device in the form of a computer 910. Components of computer 910 can include, but are not limited to, a processing unit 920, a system memory 930, and a system bus 921 that couples various system components including the system memory to the processing unit 920. The system bus 921 can be any of several types of bus structures including a memory bus or memory controller, a peripheral bus, and a local bus using any of a variety of bus architectures.

Computer 910 can include a variety of computer readable media. Computer readable media can be any available media that can be accessed by computer 910. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media can embody computer readable instructions, data structures, program modules or other data in a modulated data signal such as a carrier wave or other transport mechanism and can include any suitable information delivery media.

The system memory 930 can include computer storage media in the form of volatile and/or nonvolatile memory such as read only memory (ROM) and/or random access memory (RAM). A basic input/output system (BIOS), containing the basic routines that help to transfer information between elements within computer 910, such as during start-up, can be stored in memory 930. Memory 930 can also contain data and/or program modules that are immediately accessible to and/or presently being operated on by processing unit 920. By way of non-limiting example, memory 930 can also include an operating system, application programs, other program modules, and program data.

The computer 910 can also include other removable/non-removable, volatile/nonvolatile computer storage media. For example, computer 910 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 921 through a non-removable memory interface such as an interface, and a magnetic disk drive or optical disk drive can be connected to the system bus 921 by a removable memory interface, such as an interface.

A user can enter commands and information into the computer 910 through input devices such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 920 through user input 940 and associated interface(s) that are coupled to the system bus 921, but can be connected by other interface and bus structures, such as a parallel port, game port or a universal serial bus (USB). A graphics subsystem can also be connected to the system bus 921. In addition, a monitor or other type of display device can be connected to the system bus 921 via an interface, such as output interface 950, which can in turn communicate with video memory. In addition to a monitor, computers can also include other peripheral output devices, such as speakers and/or a printer, which can also be connected through output interface 950.

The computer 910 can operate in a networked or distributed environment using logical connections to one or more other remote computers, such as remote computer 970, which can in turn have media capabilities different from device 910. The remote computer 970 can be a personal computer, a server, a router, a network PC, a peer device or other common network node, and/or any other remote media consumption or transmission device, and can include any or all of the elements described above relative to the computer 910. The logical connections depicted in FIG. 9 include a network 971, such local area network (LAN) or a wide area network (WAN), but can also include other networks/buses. Such networking environments are commonplace in homes, offices, enterprise-wide computer networks, intranets and the Internet.

When used in a LAN networking environment, the computer 910 is connected to the LAN 971 through a network interface or adapter. When used in a WAN networking environment, the computer 910 can include a communications component, such as a modem, or other means for establishing communications over the WAN, such as the Internet. A communications component, such as a modem, which can be internal or external, can be connected to the system bus 921 via the user input interface at input 940 and/or other appropriate mechanism. In a networked environment, program modules depicted relative to the computer 910, or portions thereof, can be stored in a remote memory storage device. It should be appreciated that the network connections shown and described are exemplary and other means of establishing a communications link between the computers can be used.

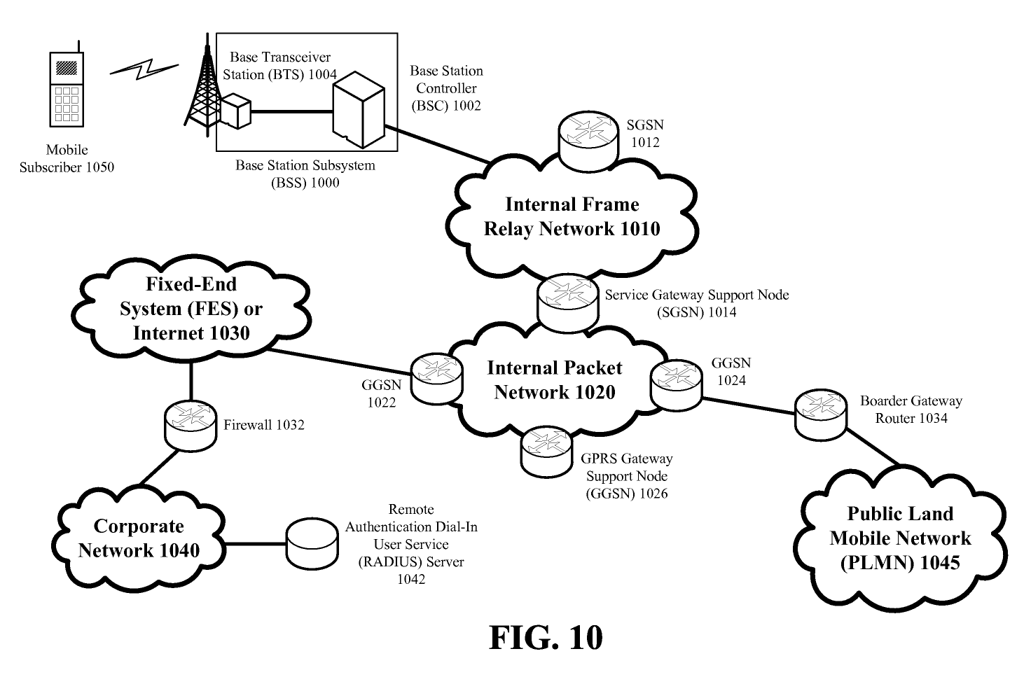

Turning now to FIG. 10, an overview of a network environment in which the claimed subject matter can be implemented is illustrated. The above-described systems and methodologies can be applied to any wireless communication network; however, the following description sets forth an exemplary, non-limiting operating environment for said systems and methodologies. The below-described operating environment should be considered non-exhaustive, and thus the below-described network architecture is merely an example of a network architecture into which the claimed subject matter can be incorporated. It is to be appreciated that the claimed subject matter can be incorporated into any now existing or future alternative communication network architectures as well.

Referring back to FIG. 10, various aspects of the global system for mobile communication (GSM) are illustrated. GSM is one of the most widely utilized wireless access systems in today's fast growing communications systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1× Evolution Data Optimized (“EVDO”), Code Division Multiple Access-2000 (“cdma2000 3×”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the timing synchronization techniques described herein may be applied independently of the method of data transport, and does not depend on any particular network architecture or underlying protocols.

FIG. 10 depicts an overall block diagram of an exemplary packet-based mobile cellular network environment, such as a GPRS network, in which the claimed subject matter can be practiced. Such an environment can include a plurality of Base Station Subsystems (BSS) 1000 (only one is shown), each of which can comprise a Base Station Controller (BSC) 1002 serving one or more Base Transceiver Stations (BTS) such as BTS 1004. BTS 1004 can serve as an access point where mobile subscriber devices 1050 become connected to the wireless network. In establishing a connection between a mobile subscriber device 1050 and a BTS 1004, one or more timing synchronization techniques as described supra can be utilized.

In one example, packet traffic originating from mobile subscriber 1050 is transported over the air interface to a BTS 1004, and from the BTS 1004 to the BSC 1002. Base station subsystems, such as BSS 1000, are a part of internal frame relay network 1010 that can include Service GPRS Support Nodes (“SGSN”) such as SGSN 1012 and 1014. Each SGSN is in turn connected to an internal packet network 1020 through which a SGSN 1012, 1014, etc., can route data packets to and from a plurality of gateway GPRS support nodes (GGSN) 1022, 1024, 1026, etc. As illustrated, SGSN 1014 and GGSNs 1022, 1024, and 1026 are part of internal packet network 1020. Gateway GPRS serving nodes 1022, 1024 and 1026 can provide an interface to external Internet Protocol (“IP”) networks such as Public Land Mobile Network (“PLMN”) 1045, corporate intranets 1040, or Fixed-End System (“FES”) or the public Internet 1030. As illustrated, subscriber corporate network 1040 can be connected to GGSN 1022 via firewall 1032; and PLMN 1045 can be connected to GGSN 1024 via boarder gateway router 1034. The Remote Authentication Dial-In User Service (“RADIUS”) server 1042 may also be used for caller authentication when a user of a mobile subscriber device 1050 calls corporate network 1040.

Generally, there can be four different cell sizes in a GSM network—macro, micro, pico, and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The claimed subject matter has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

What is claimed is:

1. A system that facilitates optimized communication with at least one wireless receiver in a wireless communication system, comprising:
a wireless transmitter that communicates with at least one wireless receiver via one or more slow fading and spatially correlated multiple-input multiple-output (MIMO) communication channels with limited feedback capacity;
a transmission adaptation component that selects a transmission mode for communicating with the at least one wireless receiver from at least one of a rate adaptation policy or a precoder adaptation policy, wherein the rate and precoder adaptation policies are jointly designed based at least in part on at least one spatial correlation characteristic of the one or more MIMO communication channels; and
one or more antennas at the wireless transmitter that communicate information to the at least one wireless receiver based on the selected transmission mode.

2. The system of claim 1, wherein the rate and precoder adaptation policies and a channel state partition set are jointly designed at least in part by performing one or more optimization algorithms based on vector quantization.

3. The system of claim 2, wherein the rate and precoder adaptation policies and the channel state partition set are further jointly designed at least in part by initializing one or more of a rate adaptation policy or a precoder adaptation policy and employing iterative optimizations to select an optimal rate adaptation policy, precoder adaptation policy, and channel state partition set.

4. The system of claim 3, wherein the rate and precoder adaptation policies and the channel state partition set are further jointly designed by initializing one or more of a rate adaptation policy or a precoder adaptation policy and performing iterative optimizations to obtain local optimal rate adaptation policies, precoder adaptation policies, and channel state partition sets for respective optimization trials and selecting a local optimal rate adaptation policy, precoder adaptation policy, and channel state partition set corresponding to an optimization trial that yields a maximum system goodput.

5. The system of claim 2, wherein the rate and precoder adaptation policies are designed based at least in part on a Gaussian distribution approximation of a conditional packet outage probability for the wireless communication system.

6. The system of claim 2, wherein an optimal precoder adaptation policy is designed such that a capacity loss corresponding to instantaneous mutual information of the wireless communication system is minimized.

7. The system of claim 2, wherein an optimal rate adaptation policy is designed based on one or more numerical optimization techniques.

8. The system of claim 1, wherein the transmission adaptation component selects a transmission mode based at least in part on feedback obtained from the at least one wireless receiver corresponding to channel state information of receiver (CSIR) estimated at the at least one wireless receiver.

9. A method of joint rate, precoder, and feedback design for a wireless communication system, comprising:
identifying a transmitting station and a receiving station operable to communicate over one or more slow fading and spatially correlated multiple-input multiple-output (MIMO) communication channels with limited feedback; and
optimizing at least a rate codebook, a precoder codebook, and a channel state information of receiver (CSIR) partitioning strategy utilized by the one or more of the transmitting station or the receiving station based at least in part on spatial correlation between the communication channels.

10. The method of claim 9, wherein the optimizing comprises optimizing the rate codebook, precoder codebook, and CSIR partitioning strategy such that a packet outage rate for information communicated from the transmitting station to the receiving station is minimized.

11. The method of claim 9, wherein the optimizing comprises optimizing the rate codebook, precoder codebook, and CSIR partitioning strategy by employing a optimization technique based at least in part on vector quantization.

12. The method of claim 10, wherein the optimizing further comprises:
initializing one or more of a rate codebook or a precoder codebook;
determining an optimal CSIR partitioning strategy based on an initialized rate codebook or precoder codebook; and
determining an optimal rate codebook and precoder codebook based on the determined optimal CSIR partitioning strategy.

13. The method of claim 12, further comprising iteratively determining an optimal CSIR partitioning strategy based on a determined optimal rate codebook or precoder codebook and determining an optimal rate codebook and precoder codebook based on the determined optimal CSIR partitioning strategy until convergence is reached.

14. The method of claim 13, further comprising:
performing the initializing and the iteratively determining an optimal CSIR partitioning strategy, rate codebook, and precoder codebook for respective trials;
determining respective system goodput values resulting from the CSIR partitioning strategies, rate codebooks, and precoder codebooks obtained in the respective trials; and
selecting a CSIR partitioning strategy, rate codebook, and precoder codebook corresponding to a trial that yields a maximum system goodput value.

15. The method of claim 11, wherein the optimizing further comprises:
approximating a conditional packet outage probability of the wireless communication system as a Gaussian distribution; and
optimizing the rate and precoder codebooks based at least in part on the approximated Gaussian distribution.

16. The method of claim 9, further comprising:
estimating CSIR at the receiving station;
selecting a partition that corresponds to the estimated CSIR based at least in part on the CSIR partitioning strategy;
identifying an index corresponding to the selected partition; and
communicating the index to the transmitting station as channel state of transmitter (CSIT) feedback.

17. The method of claim 9, further comprising:
identifying channel state information of transmitter (CSIT) feedback provided to the transmitting station by the receiving station corresponding to CSIR estimated by the receiving station; and
selecting at least one rate parameter from the rate codebook and at least one precoder parameter from the precoder codebook based at least in part on the CSIT feedback.

18. A computer-readable medium having stored thereon instructions operable to perform the method of claim 9.

19. A method of communicating via a wireless receiver with at least one wireless transmitter in a wireless communication system, comprising:
initiating wireless communication with at least one transmitter over a slow fading and spatially correlated multiple-input multiple-output (MIMO) communication channel with limited feedback capabilities; and
receiving data from the at least one transmitter over the MIMO communication channel according to dynamically and jointly determined optimal rate, preceding, and feedback adaptation policies for the wireless communication, wherein the optimal rate, preceding, and feedback adaptation policies are determined based at least in part on at least one error characteristic and at least one spatial correlation characteristic of the MIMO channel.

20. The method of claim 19, further comprising:
estimating channel state information of receiver (CSIR);
selecting a partition corresponding to the estimated CSIR based at least in part on the feedback adaptation policy; and
communicating an index corresponding to the selected partition to the at least one transmitter.
